(19) United States
(12) Patent Application Publication
(10) Pub. No.: US 2024/0185708 A1
(43) Pub. Date: Jun. 6, 2024

(54) SYSTEMS AND METHODS FOR SMART STREET LIGHTING

(71) Applicant: YIRAY TECHNOLOGY, INC., MOUNT WAVERLY (AU)

(72) Inventors: TOMMY VASSOS, BULLEEN (AU); GREG DOHERTY, BULLEEN (AU)

(73) Assignee: YIRAY TECHNOLOGY, INC., MOUNT WAVERLY, VI (AU)

(21) Appl. No.: 18/531,644

(22) Filed: Dec. 6, 2023

Related U.S. Application Data
(60) Provisional application No. 63/386,318, filed on Dec. 6, 2022.
(60) Provisional application No. 63/591,827, filed on Oct. 20, 2023.

(51) Int. Cl. G08G 1/01; G08B 25/00; H05B 47/125; H05B 47/175

(52) U.S. Cl. CPC G08G 1/0116; G08B 25/00; H05B 47/125; H05B 47/175

(57) ABSTRACT

Systems and methods are disclosed for smart street lighting concepts. In one embodiment, a smart street light device can include a solar panel, LED light array, motion sensor, wireless communications device, and computer processor. The smart street light device can be deployed individually or as a group of devices. The smart street light device can identify a moving vehicle traveling towards a monitored location; determine a distance of the moving vehicle from the monitored location; determine a speed of the moving vehicle; and control, based on the speed and proximity of the moving vehicle, a brightness of the LED light array to provide suitable lighting for the moving vehicle as it approaches the monitored location. In a group of devices, the brightness of the devices can be increased or decreased as needed to provide coordinated lighting for the moving vehicle as it approaches and/or departs the monitored location.

### RELATED APPLICATIONS

The present disclosure claims priority to U.S. Provisional Ser. No. 63/386,318, titled “Yiray Concept for Smart Street Lighting”, filed Dec. 6, 2022, and also to U.S. Provisional Ser. No. 63/591,827, titled “Associated Systems and Methods for Smart Street Lighting”, filed Oct. 20, 2023, the contents of which are both incorporated by reference.

### FIELD OF DISCLOSURE

The present disclosure is related to lighting, and more particularly to systems and methods for smart street lighting.

### BACKGROUND

Conventional street lights for roads and highways are often sporadically spaced in distance and generally do not adequately illuminate every part of the road or highway. In some areas, such as near schools and on toll roads or near toll booths, one or more cameras and speed detectors can be installed to capture images of a vehicle and the vehicle's license plate and/or speed. In any instance, many roads and highways, particularly less traveled stretches of roads and highways, may not have any street lights.

### BRIEF SUMMARY OF THE DISCLOSURE

Embodiments of the disclosure can provide systems and methods for smart street lighting. In at least one embodiment, a smart street light device can be provided with a solar panel, a LED light array, a motion sensor, a wireless communications device, and a computer processor. The smart street light device can be configured to identify a moving vehicle traveling towards a monitored street location; determine a distance of the moving vehicle from the monitored location; determine a speed of the moving vehicle; and control, based on the speed and proximity of the moving vehicle. a brightness of the LED light array to provide suitable lighting for the moving vehicle as it approaches the monitored location. In another embodiment, the smart street light device can transmit the speed and proximity of the moving vehicle to one or more adjacent smart street light devices; wherein based at least in part on the speed and proximity of the moving vehicle, a brightness of the one or more adjacent street light devices can be increased or decreased as needed to provide coordinated lighting for the moving vehicle as it approaches and/or departs the monitored location. In yet another embodiment, a group of smart street light devices can detect and transmit the speed and proximity of a moving vehicle to another group of adjacent smart street light devices; wherein based at least in part on the speed and proximity of the moving vehicle, a brightness of the group of adjacent smart street light devices can be increased or decreased as needed to provide coordinated lighting for the moving vehicle as it approaches and/or departs the monitored location.

In one embodiment, a street light device can be provided. The street light device can include an object tracking component; a communications component; a lighting component; a computer processor; and a memory storing computer-executable instructions. The computer-executable instructions can when executed by the processor, cause the processor to identify via the object tracking component a moving vehicle traveling towards a monitored street location; determine via the object tracking component a distance of the moving vehicle from the monitored street location; determine via the object tracking component a speed of the moving vehicle; and control a brightness of the lighting component based on the speed and proximity of the moving vehicle.

In one aspect of the embodiment, the computer-executable instructions can further cause the processor to transmit via the communications component a speed and proximity of the moving vehicle to one or more adjacent street light devices via one or more communication networks; wherein based at least in part on the speed and proximity of the moving vehicle, facilitate control of a brightness of the one or more adjacent street light devices.

In another aspect of the embodiment, the computer-executable instructions can further cause the processor to transmit via the communications component instructions to facilitate control of a brightness of one or more adjacent street light devices in coordination with the brightness of the lighting component.

In another aspect of the embodiment, the computer-executable instructions can further cause the processor to receive via the communications component instructions to control the brightness of the lighting component in response to an indication from one or more adjacent street light devices of a speed and proximity of the moving vehicle.

In another embodiment, a method can be provided. The method can include identifying a moving vehicle traveling towards a monitored street location; determining a distance of the moving vehicle from the monitored street location; determining a speed of the moving vehicle; controlling a brightness of one or more lighting components based on a proximity of the moving vehicle to each of the one or more lighting components; capturing one or more images of the moving vehicle as the vehicle approaches the monitored street location; detecting and/or determining a collision incident associated with the vehicle; based at least in part on the collision incident, transmitting an alert to at least one emergency service provider via one or more communication networks; and based at least in part on the collision incident, facilitating communications between a driver of the moving vehicle and the at least one emergency service provider.

In one aspect of the embodiment, the distance can be about 200 meters.

In another aspect of the embodiment, the method can include storing the one or more images in a remote storage device; and/or storing the one or more images on a local hard drive.

In yet another aspect of the embodiment, the operation of facilitating communications can include providing communications via a microphone and speaker located at the monitored street location, wherein the location of the microphone and speaker are identified with a flashing light.

In yet another aspect of the embodiment, the operation of facilitating communications can include initiating automated communications to the at least one emergency service provider regarding the collision incident at the monitored street location, wherein the automated communications comprise information associated with the vehicle.

In yet another aspect of the embodiment, the collision incident can include two or more vehicles.

In yet another aspect of the embodiment, the one or more images can include the license plate of the vehicle and the speed of the vehicle.

In yet another aspect of the embodiment, the at least one emergency service provider can include at least one of the following: police, hospital, fire department, emergency medical technician, and emergency medical transportation.

In yet another embodiment, a monitoring system can be provided. The system can include an object tracking component; a recording component; a communications component; a computer processor; and a memory storing computer-executable instructions. The computer-executable instructions can, when executed by the processor, cause the processor to identify via the object tracking component a moving vehicle traveling towards a monitored street location; determine via the object tracking component a distance of the moving vehicle from the monitored street location; determine via the object tracking component a speed of the moving vehicle; control a brightness of one or more lighting components based on a proximity of the moving vehicle to each of the one or more lighting components; capture via a recording component one or more images of the moving vehicle as the vehicle approaches the monitored street location; detect and/or determine a collision incident associated with the vehicle; based at least in part on the collision incident, transmit via the communications component an alert to at least one emergency service provider via one or more communication networks; and based at least in part on the collision incident, facilitate via the communications component communications between a driver of the moving vehicle and at least one emergency service provider.

In one aspect of the embodiment, the distance can be about 200 meters.

In another aspect of the embodiment, the system can include computer-executable instructions to further cause the processor to store one or more images in a remote storage device; and/or store of one or more images on a local hard drive.

In yet another aspect of the embodiment, the computer-executable instructions that further cause the processor to facilitate communications can further include instructions to provide communications via a microphone and speaker located at the monitored street location, wherein the location of the microphone and speaker are identified with a flashing light.

In yet another aspect of the embodiment, the computer-executable instructions that further cause the processor to facilitate communications can further include instructions to initiate automated communications to the at least one emergency service provider regarding the collision incident at the monitored street location, wherein the automated communications comprise information associated with the vehicle.

In yet another aspect of the embodiment, the collision incident can include two or more vehicles.

In yet another aspect of the embodiment, the one or more images can include the license plate of the vehicle and the speed of the vehicle.

In yet another aspect of the embodiment, the at least one emergency service provider can include at least one of the following: police, hospital, fire department, emergency medical technician, and emergency medical transportation.

### BRIEF DESCRIPTION OF THE DRAWINGS

FIG. 1 depicts an example environment for an example smart street light system according to an embodiment of the disclosure.

FIG. 2 depicts a lower perspective view of an example smart street light device in the smart street light system of FIG. 1, according to an embodiment of the disclosure.

FIG. 3 depicts an overhead upper view of the example smart street light device of FIG. 2, according to an embodiment of the disclosure.

FIG. 4 depicts a schematic view of the example smart street light device of FIGS. 2 and 3, according to an embodiment of the disclosure.

FIG. 5 depicts an example smart street light method according to an embodiment of the disclosure.

FIG. 6 depicts another example smart street light method according to an embodiment of the disclosure.

FIG. 7 depicts an example vehicle on a high risk incident stretch (HRIS) road equipped with an example smart street light system and method employing an example smart street light device, in accordance with one or more example embodiments of the disclosure.

FIG. 8 depicts an example incident associated with a vehicle on a HRIS road equipped with an example smart street light system and method employing an example smart street light device, in accordance with one or more example embodiments of the disclosure.

FIG. 9 depicts an example incident associated with a vehicle on a HRIS road equipped with an example smart street light system and method employing an example smart street light device, in accordance with one or more example embodiments of the disclosure.

The detailed description is set forth with reference to the accompanying drawings. The drawings are provided for purposes of illustration only and merely depict exemplary embodiments of the disclosure. The drawings are provided to facilitate understanding of the disclosure and shall not be deemed to limit the breadth, scope, or applicability of the disclosure. In the drawings, the leftmost digit(s) of a reference numeral may identify the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

This disclosure relates to, among other things, systems, and methods for smart street lighting. In at least one embodiment, a smart street light device can be provided with a solar panel, a LED light array, a motion sensor, a wireless communications device, and a computer processor. The smart street light device can be configured to identify a moving vehicle traveling towards a monitored street location; determine a distance of the moving vehicle from the monitored location; determine a speed of the moving vehicle; and control, based on the speed and proximity of the moving vehicle. a brightness of the LED light array to provide suitable lighting for the moving vehicle as it approaches the monitored location. In another embodiment, the smart street light device can transmit the speed and proximity of the moving vehicle to one or more adjacent smart street light devices; wherein based at least in part on the speed and proximity of the moving vehicle, a brightness of the one or more adjacent street light devices can be increased or decreased as needed to provide coordinated lighting for the moving vehicle as it approaches and/or departs the monitored location. In yet another embodiment, a group of smart street light devices can detect and transmit the speed and proximity of a moving vehicle to another group of adjacent smart street light devices; wherein based at least in part on the speed and proximity of the moving vehicle, a brightness of the group of adjacent smart street light devices can be increased or decreased as needed to provide coordinated lighting for the moving vehicle as it approaches and/or departs the monitored location.

In this manner, certain embodiments of systems and methods according to the disclosure can provide coordinated lighting for a person and/or moving vehicle approaching and/or departing a monitored location. Certain technical solutions can be achieved by various embodiments of the disclosure including energy efficiency and improved public, pedestrian, and vehicular safety. Further, the use of a solar powered lighting system can minimize the need to electrically connect street light devices using underground or overhead wires, thus potentially reducing the relative installation costs for providing smart street light devices compared to conventional lighting systems. Moreover, predictive health and maintenance monitoring of each deployed smart street light device can be performed with minimal use of physical resources, thereby potentially reducing health and maintenance costs for providing smart street light devices compared to conventional lighting systems. Finally, the technical solutions achieved by various embodiments of the disclosure can reduce power consumption compared to conventional street lighting, reduce the relative impact of street lighting on wildlife, and can reduce the relative amount of light pollution in areas with street lighting.

Certain embodiments of the disclosure can include placement of one or more lighting components in relatively dark stretches of roadways having a relatively high risk of a vehicular collision or vehicle incident. In one example embodiment, a series of solar and/or battery powered lighting components can be installed at periodic distances to illuminate a stretch of road prior to an intersection with another road and as a moving vehicle approaches the intersection. Further, at least one lighting component can include at least one camera in communication with at least one data storage device to securely store one or more images captured in real-time of associated vehicle information including, but not limited to, exterior of the vehicle, a license plate number, vehicle speed, vehicle location, and vehicular collision or vehicle incident information. In another example, each lighting component can also include one or more sensors to track and identify one or more vehicles and vehicular collision or vehicle incident information. An artificial intelligence (AI) or smart component can detect or otherwise determine that a vehicular collision or vehicle incident has occurred. In response to a vehicular collision or vehicle incident, information including one or more images can be transmitted to at least one emergency service provider, and multiple emergency service providers can be contacted depending on a type of vehicular collision or vehicle incident that has been detected or otherwise determined to have occurred. At least one lighting component at the monitored street location, such as at the intersection, can also facilitate communications between a person associated with a vehicle involved in a vehicular collision or vehicle incident and at least one emergency service provider.

In this manner, certain embodiments of systems and methods according to the disclosure can achieve various technical solutions including assisting in subsequent care of injured or endangered persons at a site of a vehicular collision or other vehicle incident. Certain embodiments of systems and methods can also achieve certain technical solutions including expediting response time and suitable emergency resources to respond to vehicular collisions and vehicle incidents and thereby reduce the severity of injuries suffered by persons due to any delay in reporting the vehicular collision or vehicle incident to an emergency service provider. Further, certain embodiments of systems and methods can also achieve certain technical solutions to ensure timely, relatively accurate, and consistent reporting of a detected or other determined vehicular collision or vehicle incident.

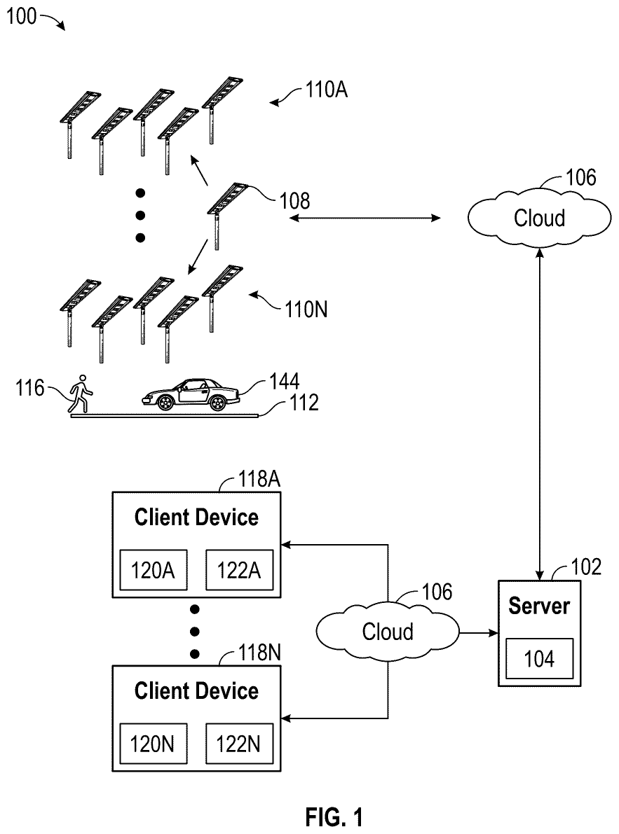

FIG. 1 depicts an example environment for an example smart street light system according to an embodiment of the disclosure. In FIG. 1, a smart street light system 100, also referred to as a monitoring system, can include a server 102 with a server control module 104. The server 102 can be in communication via one or more networks 106 with a smart street light device 108. The smart street light device 108 can be deployed individually or can be deployed in groups, such as 110A-110N. A group of smart street light devices can include any number of smart street light devices, such as 108. In any instance, each smart street light device, such as 108, 110A-110N, can be positioned adjacent to a location, such as a road 112, to monitor and illuminate the road for vehicles 114 and persons 116 traveling on the road 112 or in the location. In certain embodiments, groups of smart street light devices 110A-110N can be deployed in these locations as well as other locations where pedestrian safety and/or vehicular safety may be a priority. Example locations can include, but are not limited to, roads, streets, highways, paths, trails, sidewalks, intersections, and buildings.

In any instance, to facilitate coordinated control of one or more smart street light devices, such as 108, and groups of smart street light devices such as 110A-110N, communications with a smart street light device 108 and/or group of smart street light devices such as 110A-110N can be implemented via one or more networks 106. One or more networks can include a wireless or wired network, satellite communications, or any other communications technology or protocol that permits communications between smart street light devices. Further, communications with a street light device 108 and/or group of smart street light devices such as 110A-110N can be implemented via a mesh network technology, WiFi, Bluetooth, or other suitable protocol or technology that permits individual devices to communicate with some or all devices in a group. Moreover, communications between one group of smart street light devices such as 110A and another group of smart street light devices such as 110N can be implemented via a mesh network technology, WiFi, Bluetooth, or other suitable protocol or technology that permits one group of devices to communicate with one or more groups of devices. In some embodiments, communications between one or more smart street light devices and/or groups of smart street light devices can be through a wired connection.

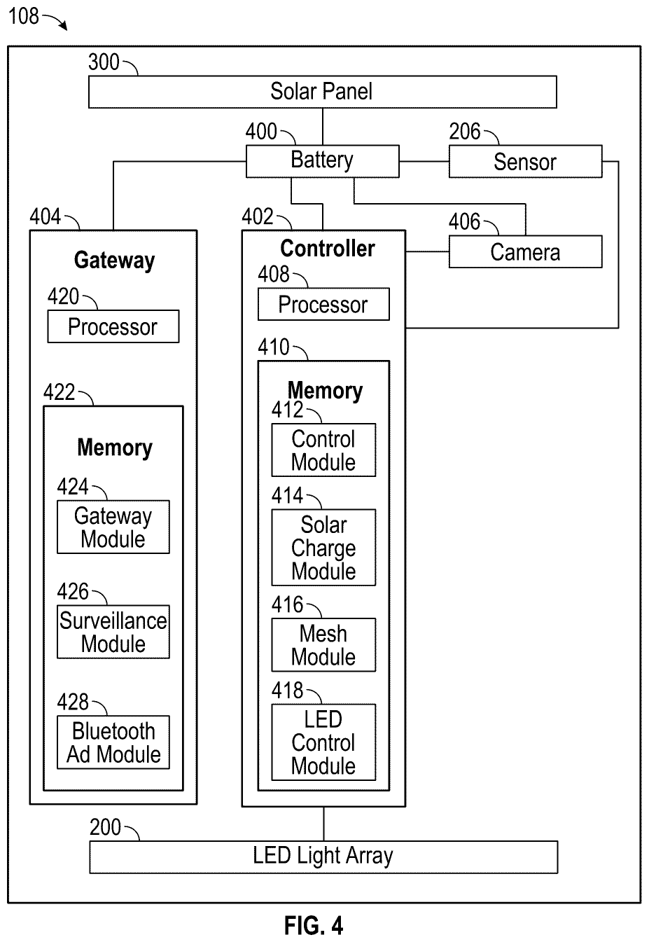

In one example in the embodiment shown in FIG. 1, control of one or more smart street light devices can be implemented by a respective smart street light device, such as 108, which may execute instructions in a control module stored in an associated memory device, as shown in FIG. 4.

In another example in the embodiment shown in FIG. 1, control of one or more smart street light devices can be implemented by a respective group of smart street light devices, such as 110A-110N, which may execute instructions in a gateway module stored in an associated memory device, as shown in FIG. 4.

In yet another example in the embodiment shown in FIG. 1, control of one or more smart street light devices can be implemented by the server 102, which may execute instructions in a server control module 104 stored in an associated memory device of the server 102.

In the embodiment shown in FIG. 1, the server 102 and server control module 104 can be in communication via one or more networks 106 with at least one client device, such as 118A. The client device 118A can execute an application program 120A with a user interface to permit a user to interact with the server 102 and server control module 104. The server 102 and server control module 104 can facilitate further interactions via at least one network 106 with one or more smart street light devices, such as 108, and/or one or more groups of smart street light devices, such as 110A-110N. A server such as 102 can be operated as a shared cloud service device, or may be a private cloud service device. In any instance, an application program can be a mobile application program or app executing on a smart phone or cellphone associated with a user, wherein the user can access via a user interface associated with the app to monitor, configure, and access information from one or more smart street light devices, such as 108, 110A-110.

In the embodiment shown in FIG. 1, a client device such as 118N can execute an application program 120N with a user interface to permit a user to interact with the server 102 and server control module 104. The server 102 and server control module 104 can facilitate further interactions via at least one network 106 with one or more smart street light devices, such as 108, and/or one or more groups of smart street light devices, such as 110A-110N. In any instance, an application program can be an Internet browser application program executing on a desktop or laptop computer associated with a user, wherein the user can access via a user interface associated with the Internet browser application program to monitor, configure, and access information from one or more smart street light devices, such as 108, 110A-110.

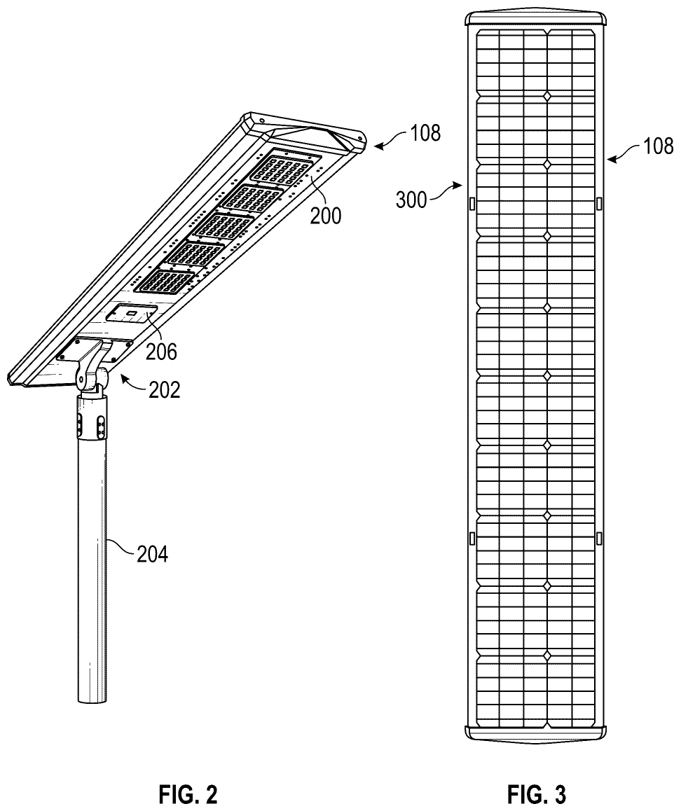

FIG. 2 depicts a lower perspective view of an example street light device in the smart street light system of FIG. 1, according to an embodiment of the disclosure. The smart street light device 108 shown in FIG. 2 can be a rectangular box-shaped unit with a lighting component, such as a LED light array 200, a pole mount 202, a pole 204, and an object tracking component, such as a motion sensor 206. In certain embodiments, a smart street light device such as 108 can be mounted, for example, on a vertically-oriented pole 204. The pole mount 202 shown in FIG. 2 can be located adjacent to an edge of the smart street light device 108 and can include a recess with a swivel-type mechanism to permit the smart street light device 108 to pivot with respect to the pole 204. In other embodiments, a pole mount could be located on a lateral edge or other surface of the smart street light device 108 to accommodate positioning the smart street light device 108 in a variety of different locations, such as from a horizontal or angled surface, or from an extended post arm.

In any instance, as shown in FIG. 2, the LED light array 200 can be a rectangular-shaped panel located on a lateral surface of the smart street light device 108, and can facilitate providing relatively energy efficient lighting in the direction that the lateral surface to which it is mounted is directed at.

Further, as shown in FIG. 2 and further explained below in FIG. 4, the motion sensor 206 can be positioned adjacent to the LED light array 200. The motion sensor 206, which is also referred to as a sensor or object tracking component, can be located on the same lateral surface of the smart street light device 108 as the LED light array, but in some instances, could be located on a different surface or may be a separate component from the smart street light device 108. In any instance, the motion sensor 206 can detect movement adjacent to the smart street light device 108, and communicate information regarding a moving object, such as a person or vehicle, to the street light device 108 to facilitate control, such as the brightness, of the LED light array 200. In one example, the motion sensor 206 may detect movement of a person, animal, or vehicle adjacent to the smart street light device 108, and the sensor 206 can generate a signal to transmit to facilitate control of the LED light array 200 to activate the LED light array 200 to illuminate the adjacent location as needed.

In certain embodiments, more than one sensor can be incorporated into a smart street light device 108. Suitable sensors can include, but are not limited to, infrared sensors; environmental sensors such as temperature, humidity, and lighting; acoustic sensors, vibration sensors, radar sensors, and sensors trained to detect certain shapes such as persons, animals, and/or vehicles. In other embodiments, one or more sensors external to the smart street light device 108 can provide information regarding a moving object, such as a person or vehicle, to the street light device 108 to facilitate control, such as the brightness, of the LED light array 200.

In FIG. 3 an overhead upper view is depicted of the example smart street light device 108 of FIG. 2, according to an embodiment of the disclosure. The smart street light device 108 shown in FIG. 3 can include a rectangular-shaped solar panel 300. The solar panel 300 can receive sunlight to convert into an electrical charge to provide to an internal energy storage device, such as a battery 400 described below in FIG. 4. The solar panel 300 shown in FIG. 3 can be located on an upper lateral surface of the smart street light device 108, but in some instances, could be located on a different surface or may be a separate component from the smart street light device 108. In any instance, the solar panel 300 can generate an electrical charge to a battery 400, or in other instances to directly power certain components of the smart street light device 108.

FIG. 4 depicts a schematic view of the example smart street light device of FIGS. 2 and 3, according to an embodiment of the disclosure. In addition to the components described above in FIGS. 2 and 3, the smart street light device 108 shown in FIG. 4 can also include a battery 400, controller 402, a gateway 404, and a camera 406. The battery 400 can be an energy storage device configured to receive an electrical charge generated by the solar panel 300, and further configured to convert the electrical charge to charge the battery for subsequent use. The battery 400 can be electrically connected to the controller 402 to power the controller 402, and when needed, the battery 400 can provide an electrical current to the LED light array 200 to facilitate providing light from the LED light array 200. Further, the battery 400 can be electrically connected to the gateway 404, sensor 206, and camera 406 to provide an electrical current to power these respective components as needed.

The camera 406, also referred to as a recording component, shown in FIG. 4 can be an IP protocol camera configured to capture, store, and transmit one or more images and audio to a remote location, such as a server 102 and/or client device 118A-118N. In the example shown, the camera 406 can communicate with the controller 402, which can locally store images and audio and transmit stored and/or live information as needed. In certain embodiments, the camera 406 can receive control information, such as PTZ (pan, tilt, and zoom) control instructions to observe an object and/or event adjacent to the smart street light device 108. Collectively, a group of smart street light devices such as 110A-110N can be instructed to have their respective cameras observe an object and/or event adjacent to the group of smart street light devices 110A-110N.

In any instance, the controller 402 can selectively control some or all of the components of the smart street light device 108 as needed. The controller can include a processor 408, a memory device such as memory 410, a set of computer-executable instructions stored in the memory 410 as a control module 412 also known as a communications component, a set of computer-executable instructions stored in the memory 410 as a solar charge module 414, a set of computer-executable instructions stored in the memory 410 as a mesh module 416 also referred to as a communications component, and a set of computer-executable instructions stored in the memory 410 as a LED control module 418. Each of the sets of computer-executable instructions or respective modules 412, 414, 416, 418 can be executed as needed by the processor 408 to facilitate control of the controller 402, battery 400, gateway 404 also referred to as a communications component, and LED light array 200, and to communicate with the gateway 404 and other components.

In one embodiment, the control module 412 can facilitate identifying a location and time associated with the deployed smart street light device by way of a GPS (global positioning satellite) signal receiver component or other location determination device. In one example, the control module 412 can communicate with a GPS receiver component associated with the smart street light device 108, and receive one or more location and time indications from the GPS receiver component to determine a location and time associated with the smart street light device 108.

In another example, the control module 412 can facilitate identifying a location and time associated with a person or vehicle by way of a GPS (global positioning satellite) signal receiver component or other location determination device associated with the person or vehicle. In one example, the control module 412 can communicate with a GPS receiver component associated with the person or vehicle, and receive one or more location and time indications from the GPS receiver component to determine a location and time associated with the person or vehicle.

In one embodiment, the control module 412 can also include or otherwise communicate with an AI (artificial intelligence) or smart component or otherwise implement suitable instructions and/or logic to analyze one or more images, vehicle information, incident information and/or vehicular collision information that has been previously stored or otherwise received by the smart street light device 108. The control module 412 can then generate suitable alerts and/or communications to transmit to one or more emergency service providers in response to detecting or otherwise determining a vehicle incident and/or vehicular collision has occurred. In some instances, the control module 412 can communicate with the server 102 and/or client device 118A118N, which may include an AI (artificial intelligence) or smart component or otherwise implement suitable instructions and/or logic to analyze one or more images, vehicle information, incident information and/or vehicular collision information to provide to the control module 412.

In one embodiment, the control module 412 can facilitate providing smart health and maintenance monitoring of the deployed smart street light device by conducting a predetermined set of checks on one or more components of the smart street light device 108. For example, the control module 412 can conduct a check of, monitor, and store measurements for the minimum and maximum brightness of the LED light array 200, the charging capacity of the battery 400, and electrical voltage and current of the LED light array 200 and battery 400. The values of these measurements can be stored by the control module 412 and can be stored and transmitted as needed to a remote location, such as the server 102 or a client device 118A-118N.

In one embodiment, the control module 412 can facilitate remote management and configuration of the deployed smart street light device by providing certain control inputs to the smart street light device from a remote location, such as the server 102 or a client device 118A118N. For example, a control input can include, but is not limited to, configuring on and/or off times, configuring brightness level of an associated LED light array, configuring threshold alerts for one or more measurements on one or more components of the smart street light device, and updating configurations, firmware and/or software in one or more components of the smart street light device. Further, the control module 412 can facilitate remote management of the deployed smart street light device by providing certain information associated with the smart street light device to a remote location, such as the server 102 or a client device 118A-118N. The provided information can include, but is not limited to, on/off times of the smart street light device, brightness of the LED light array, charging statistics for the battery, load statistics for the smart street light device, motion detection events, status of lighting provided by the smart street light device, ambient temperature and temperature of one or more components of the smart street light device, location and time associated with the smart street light device, one or more measured or estimated characteristics of one or more components of the smart street light device.

In yet another example, the control module 412 can facilitate analysis of data from one or more smart street light devices in a group of smart street light devices to evaluate the performance of the one or more smart street light devices compared to smart street light devices in similar locations. The analysis by the control module 412 may indicate that certain configurations of one more smart street light devices may not be optimal, such as the location of one or more smart street light devices, the timing of turning on and/or off of one or more smart street light devices, or the brightness of one or more smart street light devices when turned on. In some instances, the analysis by the control module 412 may indicate that one or more smart street light devices may need maintenance and/or replacement. In these instances, a relatively low charging characteristic of a particular smart street light device compared to a group of smart street light devices may indicate the need for cleaning the smart street light device, or a relatively low power drain at night time for a particular smart street light device may indicate a faulty LED light array. In other instances, an analysis by the control module 412 may indicate that one or more particular smart street light devices may have a relatively high power drain, thus indicating that these smart street light devices should be reconfigured to decrease the brightness of the LED light array and/or frequency or timing of the smart street light devices being turned on.

In one example, communications facilitated by the control module 412 to the server 102 or a client device 118A-118N can be encrypted using a suitable wireless communications encryption protocol, thus facilitating end-to-end encryption for communications between one or more smart street light devices and a remote location, such as the server 102 or a client device 118A-118N.

By way of further example, the solar charge module 414 can facilitate control and monitoring of the interactions between the LED light array 200, solar panel 300, and battery 400 to permit the charging of the battery 400 with electrical current generated by the solar panel 300, and selective use of the battery 400 to power the LED light array 200 and to control the brightness of the LED light array 200.

Further, for example, the mesh module 416 can facilitate control of the smart street light device 108 in a group of smart street light devices that collectively can function as a network of smart street light devices. The mesh module 416 can provide instructions to the smart street light device 108 as well as other smart street light devices as needed to communicate via at least one communication network such as 106 and/or directly between smart street light devices via a wireless communication protocol such as WiFi or Bluetooth. As needed, the mesh module 416 can coordinate with the gateway 404 as needed to establish and facilitate communications between smart street light devices and/or between one or smart street light devices and one or more networks, such as 106. In any instance, the mesh module 416 can facilitate creating a network of smart street light devices that can collectively receive and transmit information with a remote location such as a server 102 or a client device 118A-118N. In this manner, a single network connection with a remote location, such as with server 102, can be established and maintained rather than multiple network connections.

In one embodiment, the mesh module 416, also referred to as a communications component, can facilitate communications with at least one other smart street light device, such that the smart street light device 108 can communicate with the other smart street light device, such one in a group of smart street light devices 110A-110N. In this example, communications between the smart street light device 108 and the other smart street light device can be encrypted using a suitable wireless communications encryption protocol, thus facilitating end-to-end encryption for communications between smart street light devices.

In one example, the mesh module 416 can be configured to turn on the LED light array 200 ahead of an approaching person or vehicle when detected by the motion sensor or by a motion sensor in a group of smart street light devices, and coordinated lighting from the LED light arrays of the group of smart street light devices can be turned on ahead of the approaching person or vehicle along a path with a deployment of the group of smart street light devices.

In another example, the mesh module 416 can be configured to share one or more detected motion events from a smart street light device with one or more other smart street light devices in a group of smart street light devices. The detected motion events could be analyzed by the controller 402 and/or mesh module 416 to predict where subsequent motion events may occur, and the mesh module 416 can be configured to control one or more smart street light devices in a group of smart street light devices to turn on lighting in the locations where the predicted motion events will occur.

In yet another example, the mesh module 416 can be configured to share one or more detected motion events from a smart street light device with one or more other smart street light devices in a group of smart street light devices to control one or more smart street light devices in a group of smart street light devices to turn on lighting and/or adjust the brightness of the lighting in the locations where the one or more other smart street light devices in a group of smart street light devices are located.

Moreover, for example, the LED control module 418 can be configured to control an output of the LED light array 200. In one example, the LED control module 418 can be configured to turn on the LED light array 200 for a fixed duration, such as from about sunset to about sunrise, or to turn on the LED light array 200 at about 30 minutes after sunset and turn off the LED light array about 30 minutes before sunrise. In another example, the LED control module 418 can be configured to turn on the LED light array 200 at a fixed time, such as to turn on the LED light array 200 at about 6:00 p.m. and to turn off the LED light array 200 at about 1:00 a.m. By way of another example, the LED control module 418 can be configured to control the brightness of the LED light array 200 based on predefined increments of a time period, such as the night time. In this example, increments could be for the first 25% of the night time, control the brightness of the LED light array 200 to output at about 50% brightness; for the next 25% of the night time control the brightness of the LED light array 200 to output at about 40% brightness; for the next 25% of the night time control the brightness of the LED light array 200 to output at about 20% brightness; and for the last 25% of the night time control the brightness of the LED light array 200 to output at about 5% brightness. In this manner, as night time becomes relatively shorter or longer during the time of year, the brightness of the LED light array 200 in a smart street light device can be suitably controlled. Further, the LED control module 418 can be configured to turn on the LED light array 200 based at least in part on detecting a particular event, such as a motion detected by the motion sensor 206. In this example, a duration such as number of seconds, and brightness for the LED light array 200 can be set for when a vehicle or person is detected by the motion sensor 206. In another example, the LED control module 418 can be configured to turn on the LED light array 200 as a person or vehicle is detected by the motion sensor, and coordinated lighting from the LED light arrays of a group of smart street light devices can be turned on and off as the person or vehicle is detected moving along a path with a deployment of the group of smart street light devices.

In the embodiment shown in FIG. 4, the gateway 404, also referred to as a communications component or an extension component, can include a gateway processor 420, a memory device such as gateway memory 422, a set of computer-executable instructions stored in the memory 422 as a gateway module 424, a set of computer-executable instructions stored in the memory 410 as a surveillance module 426, and a set of computer-executable instructions stored in the memory 410 as a Bluetooth ad module 428. Each of the sets of computer-executable instructions or respective modules 424, 426, 428 can be executed as needed by the gateway processor 420 to facilitate control of the gateway 404 and to communicate with the controller 402 and other components of the smart street light device 108 as needed.

For example, the gateway module 424 can facilitate providing communications via 4G and/or 5G standards for the gateway processor 420 and gateway 404 to communicate with one or more smart street light devices, such as 108, 110A-110N, the server 102, and one or more client devices 118A-118N. For example, the gateway module 424 can facilitate communications for the smart street light device 108 to communicate via the Internet with a remote location, such as the server 102 and the server control module 104 to permit coordinated control of the smart street light device 108 with a group of smart street light devices such as 110A-110N.

By way of further example, the surveillance module 426 can facilitate control of the camera 406 associated with the smart street light device. One or more images including audio data, such as a live stream, can be communicated from the camera 406 at location of the smart street light device 108 via the Internet to a remote location, such as the server 102 and/or client devices 118A-118N to permit a user to view and listen to events at the location of the smart street light device 108. Collectively, images and audio from the cameras associated with a group of smart street light devices can provide a user with information needed to make emergency or other response decisions with respect to events observed at the location of the group of smart street light devices. In any instance, images, audio data, and other information collected by the surveillance module 426 and associated smart street light 108 can be stored and transmitted as needed by the gateway 404 to a remote location such as the server 102 and/or client devices 118A-118N.

Further, for example, the Bluetooth ad module 428 can facilitate control of advertising or marketing communications to be transmitted to one or more applications executing on a user's client device, such as a smart phone or cellphone, when the user is in proximity of the smart street light device 108. Advertising or marketing communications, such as ads or tourism information, can be transmitted from a remote location, such as the server 102 and/or client devices 118A118N, to the smart street light device 108 to permit a user who is in proximity of the smart street light device 108 to view the ad on his or her smart phone or cellphone. Collectively, a group of smart street light devices such as 110A-110N can provide one or more advertising or marketing communications, such as ads or tourism information, to a user viewing a smart phone or cellphone as the user travels in proximity to the group of smart street light devices.

In the embodiment shown in FIG. 4, the camera 406 can be incorporated into a smart street light device 108. The camera 406 can be in communication with the battery 400, controller 402, sensor 206, and a memory device such as 410. In other embodiments, one or more cameras external to the smart street light device 108 can provide information regarding a moving object, such as a person or vehicle, to the controller 402 and/or other components of the street light device 108 to facilitate control, such as the brightness, of the LED light array 200. In any instance, a camera can capture, record, and store one or images of a moving object adjacent to the smart street light device 108.

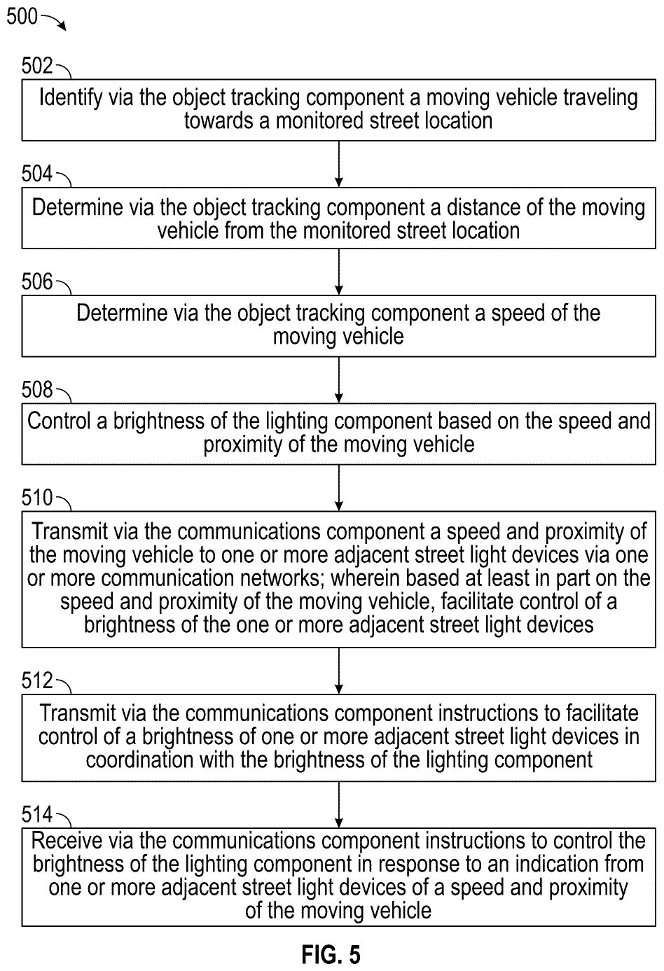

FIG. 5 depicts an example smart street light method according to an embodiment of the disclosure. The method 500 can be implemented by the example system 100 shown in FIG. 1, and various system components shown in FIGS. 2, 3, and 4. The method 500 begins at block 502.

In block 502, the method 500 can include identifying via the object tracking component a moving vehicle traveling towards a monitored street location.

Block 502 is followed by block 504, in which the method 500 can include determining via the object tracking component a distance of the moving vehicle from the monitored street location.

Block 504 is followed by block 506, in which the method 500 can include determining via the object tracking component a speed of the moving vehicle.

Block 506 is followed by block 508, in which the method 500 can include controlling a brightness of the lighting component based on the speed and proximity of the moving vehicle.

Block 508 is followed by block 510, in which the method 500 can include transmitting via the communications component a speed and proximity of the moving vehicle to one or more adjacent street light devices via one or more communication networks; wherein based at least in part on the speed and proximity of the moving vehicle, facilitate control of a brightness of the one or more adjacent street light devices.

Block 510 is followed by block 512, in which the method 500 can include transmitting via the communications component instructions to facilitate control of a brightness of one or more adjacent street light devices in coordination with the brightness of the lighting component.

Block 512 is followed by block 514, in which the method 500 can include receiving via the communications component instructions to control the brightness of the lighting component in response to an indication from one or more adjacent street light devices of a speed and proximity of the moving vehicle.

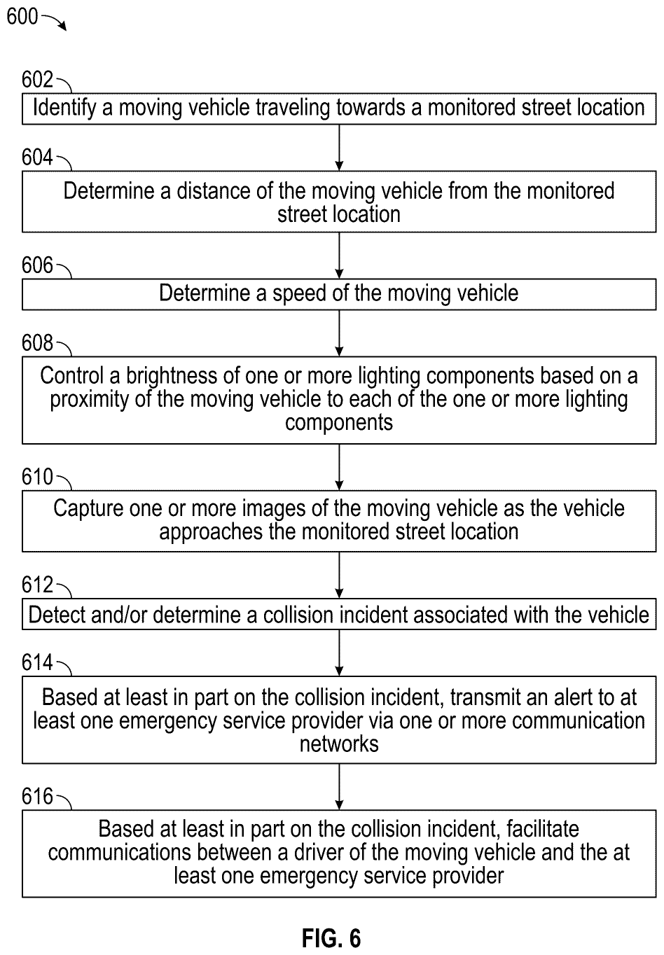

FIG. 6 depicts another example smart street light method according to an embodiment of the disclosure. The method 600 can be implemented by the example system 100 shown in FIG. 1, and various system components shown in FIGS. 2, 3, and 4. The method 600 begins at block 602.

In block 602, the method 600 can include identifying a moving vehicle traveling towards a monitored street location.

Block 602 is followed by block 604, in which the method 600 can include identifying a moving vehicle traveling towards a monitored street location.

Block 604 is followed by block 606, in which the method 600 can include determining a distance of the moving vehicle from the monitored street location.

Block 606 is followed by block 608, in which the method 600 can include determining a speed of the moving vehicle.

Block 608 is followed by block 610, in which the method 600 can include controlling a brightness of one or more lighting components based on a proximity of the moving vehicle to each of the one or more lighting components.

Block 610 is followed by block 612, in which the method 600 can include capturing one or more images of the moving vehicle as the vehicle approaches the monitored street location.

Block 612 is followed by block 614, in which the method 600 can include detecting and/or determining a collision incident associated with the vehicle.

Block 614 is followed by block 616, in which the method 600 can include transmitting, based at least in part on the collision incident, an alert to at least one emergency service provider via one or more communication networks.

Block 616 is followed by block 618, in which the method 600 can include facilitating, based at least in part on the collision incident, communications between a driver of the moving vehicle and the at least one emergency service provider.

In at least one aspect of the embodiment, the method 600 can include storing the one or more images in a remote storage device; and/or storing the one or more images on a local hard drive.

In at least one aspect of the embodiment, the method 600 can include facilitating communications which can include providing communications via a microphone and speaker located at the monitored street location, wherein the location of the microphone and speaker are identified with a flashing light.

In at least one aspect of the embodiment, the method 600 can include facilitating communications which can include initiating automated communications to the at least one emergency service provider regarding the collision incident at the monitored street location, wherein the automated communications comprise information associated with the vehicle.

For the methods 500, 600 disclosed in FIGS. 5 and 6, any number of operations can be implemented to perform these methods 500, 600, and these are merely provided as examples of the methods according to embodiments of the disclosure.

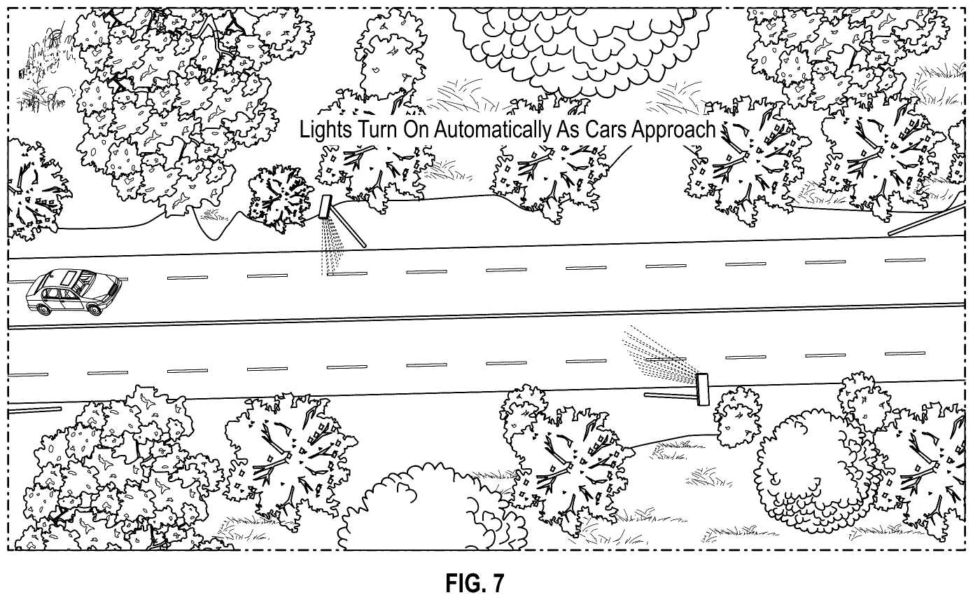

FIGS. 7-9 illustrate an example implementation of certain systems and methods, in accordance with one or more example embodiments of the disclosure. One will recognize that the example system 100 shown in FIG. 1, and various system components shown in FIGS. 2, 3, and 4 can be used to implement the example shown in FIGS. 7-9.

FIG. 7 depicts an example vehicle on a high risk incident stretch (HRIS) road equipped with an example smart street light system and method employing an example smart street light device, in accordance with one or more example embodiments of the disclosure. In one or more embodiments, a smart street light system, also referred to as a monitoring system, can include one or more smart street light devices, each with at least one lighting component, object tracking component, recording component, communications component, and computer processor. The computer processor can include a memory storing computer-executable instructions, that when executed by the processor, cause the processor to identify via the object tracking component a moving vehicle traveling towards a monitored street location or intersection. An example smart street light system is shown as 100 in FIGS. 1-4, and used in a Yiray Technology Monitored Blackspot Intersection system provided by Yiray Technology, Inc. of Victoria, Australia. The computer processor can also include an AI (artificial intelligence) or smart component or otherwise implement suitable instructions and/or logic to analyze one or more images, vehicle information, incident information and/or vehicular collision information that has been previously stored or otherwise received by the monitoring system. The computer processor can then generate suitable alerts and/or communications to transmit via the communications component to one or more emergency service providers in response to detecting or otherwise determining a vehicle incident and/or vehicular collision has occurred.

In the embodiment shown in FIG. 7, the example smart street light device can include one or more lighting components. An example of a suitable lighting component is a LED light array 200 shown in FIGS. 2, 3, and 4, and used in a Yiray Technology Monitored Blackspot Intersection system. In one or more embodiments, certain smart street light systems and methods can provide one or more smart street light devices, each with respective lighting components, at periodic distances beginning at about 200 meters away from the monitored street location or intersection to illuminate a stretch of road prior to the intersection with another road. A monitored street location can include, but is not limited to, a stretch of heavily traveled road, a pedestrian right of way or crosswalk, a merging of two or more roads, or any pointing featuring a turning lane onto a roadway.

In one or more embodiments, certain smart street light systems and methods can provide one or more smart street light devices, each with respective lighting components, that can adjust their respective brightness based on a proximity of a moving vehicle to each of the one or more lighting components. That is, the lighting components can switch on and off, or otherwise adjust their brightness, as a vehicle approaches a first light in a series of lighting components, for example, about 20 meters away, and then when the vehicle approaches the next light, about 20 meters away, and so on.

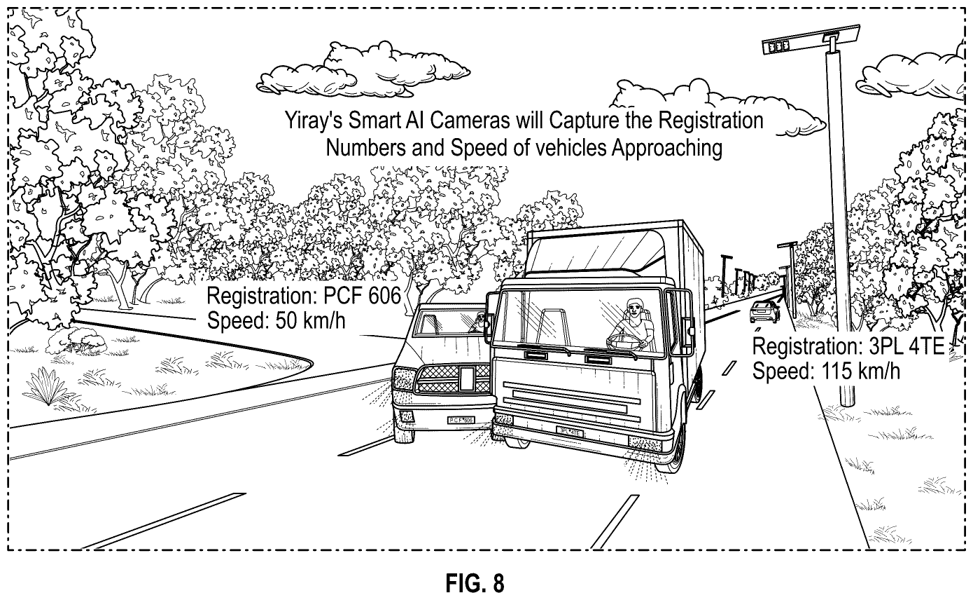

FIG. 8 depicts an example incident associated with a vehicle on a HRIS road equipped with an example smart street light system and method employing one or more example smart street light devices, in accordance with one or more example embodiments of the disclosure. In one or more embodiments, certain smart street light systems and methods can provide one or more smart street light devices, each with respective recording components, to capture at least one image of the vehicle, the license plate of the vehicle, the speed or velocity of the vehicle, and vehicular collision or vehicle incident information. Such smart street light systems and methods can continue to monitor the vehicle as the vehicle approaches and passes each smart street light device until the vehicle reaches the intersection.

In the embodiment shown in FIG. 8, the smart street light system can include one or more example smart street light devices, each with respective tracking components to determine a distance of a moving vehicle from the monitored street location such as an intersection. In one example, a smart street light device used in a Yiray Technology Monitored Blackspot Intersection system can include at least one object tracking component, such as the motion sensor 206 shown and described in FIG. 2. In one example, one or more object tracking components can be mounted in any number of smart street light devices in a smart street light system. The object tracking component can detect the presence and movement of the car on the road. When the car approaches a monitored street location such as an intersection of two roads, the object tracking component can determine the distance of the car from the intersection. In some instances, a monitored street location may be a HRIS road which can include, but is not limited to, a stretch of heavily traveled road, a pedestrian right of way or crosswalk, a merging of two or more roads, or any pointing featuring a turning lane onto a roadway.

In one or more embodiments, the smart street light systems and methods may include one or more example smart street light devices, each with at least one object tracking component to track a vehicle approaching a monitored intersection. Embodiments of the smart street light systems and methods may calculate the distance between the vehicle and the monitored intersection as the vehicle approaches, beginning at about 200 meters away from the intersection.

In the embodiment shown in FIG. 8, each object tracking component can determine a speed or velocity of a moving vehicle on a road. When the car travels towards the monitored street location, each object tracking component can detect or otherwise determine the speed of the moving vehicle on the road.

In certain embodiments, the object tracking component can include one or more sensors to determine the distance of a moving vehicle from the monitored street location and the speed or velocity of the moving vehicle on a road. For example, the object tracking component may include a sensor that can measure how far the vehicle is from a predefined marker that is about 200 meters away from the monitored street location such as an intersection of two roads. In another example, the object tracking component may include a sensor that can measure the distance between the moving vehicle and the monitored street location. Further, the object tracking component may include a speed sensor that can measure the speed of the moving vehicle on the road. In another example, the object tracking component may include or otherwise coordinate with a GPS (global positioning satellite) information receiver capable of receiving GPS information from the moving vehicle and/or associated with the vehicle, and determine the distance and speed of the moving vehicle.

In the embodiment shown in FIG. 8, the smart street light system can include one or more example smart street light devices, each with at least one recording component that can capture one or more images of the moving vehicle as the vehicle approaches the monitored street location.

In one example, a smart street light device used in a Yiray Technology Monitored Blackspot Intersection system can include a recording component such as camera 406 shown and described in FIG. 4, that can capture, via either a still image or a video, associated vehicle information including, but not limited to, an exterior view of the vehicle, a license plate number, a vehicle speed, a vehicle location, and any collision incident information. The recording component can capture one or more images of the vehicle. When the vehicle approaches a monitored street location such as an intersection of two roads, the recording component can collect vehicle identifying information such as the license plate, vehicle identification number (VIN) or other unique identifier associated with the car, and speed of the car. In some instances, a monitored street location may be a high risk incident stretch of road (HRIS) which can include, but is not limited to, a stretch of heavily traveled road, a pedestrian right of way or crosswalk, a merging of two or more roads, a relatively sharp curve in a road, a relatively steep change in elevation, or any stretch of road having a turning lane. In certain embodiments, a text reader component or license plate reader component can identify the license plate, vehicle identification number (VIN) or other unique identifier associated with the car.

In one or more embodiments, the smart street light systems and methods may include one or more example smart street light devices, each configured for capturing a photo or recording a video of the vehicle's license plate and speed as the vehicle approaches the intersection. The smart street light system may then automatically transmit the information to emergency services to increase responsiveness with incidents. In at least one aspect of certain embodiments, one or more images can include, but are not limited to, an exterior view of the vehicle, a license plate of the vehicle, and a speed or velocity of the vehicle.

In one example, one or more recording components can be mounted in any number of smart street light devices in a smart street light system. In certain embodiments, each recording component can transmit the one or more collected images to any number of local and/or remote storage locations. In one example, each recording component can transmit the one or more collected images to an online remote storage device or provider. In another example, each recording component can transmit the one or more collected images to a local hard drive or storage device. In some instances, the respective storage locations can store the one or more collected images for subsequent implementation, including, though not limited to, transmission of the images to one or more emergency service providers.

In at least one aspect of certain embodiments, each recording component can store one or more images in a remote storage device, such as a memory device. In some instances, the recording component can store one or more images on a local hard drive.

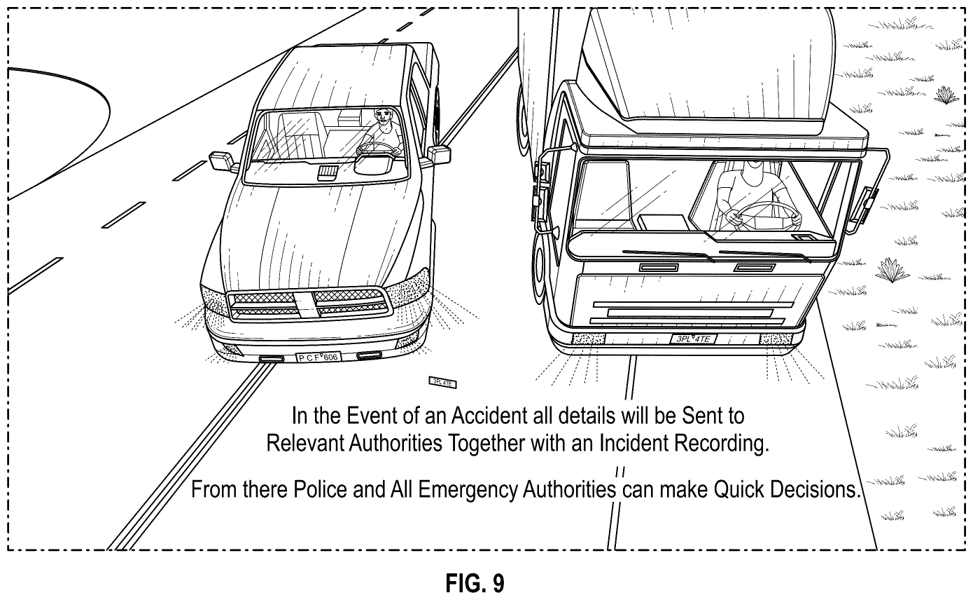

FIG. 9 depicts an example incident associated with a vehicle on a HRIS road equipped with an example smart street light system and method with one or more example smart street light devices, each with at least one respective communication component, in accordance with one or more example embodiments of the disclosure. In the embodiment shown in FIG. 9, each communications component can transmit information between the drivers of the vehicles and the emergency service providers. In one example, a smart street light device used in a Yiray Technology Monitored Blackspot Intersection system can include a communications component. In one example, the communications component can transmit associated vehicle information including, but not limited to, an exterior view of the vehicle, a license plate number, a vehicle speed, a vehicle location, and any collision incident information to emergency service providers. In one example, a vehicle such as a car or multi-passenger vehicle can be traveling a road equipped with a Yiray Technology Monitored Blackspot Intersection system and collide with an object or another vehicle such as a car or multi-passenger vehicle. The communications component can transmit vehicle identifying information such as the license plate, vehicle identification number (VIN) or other unique identifier associated with the car, and speed of the car to emergency service providers prior to arrival on the scene. In some instances, a monitored street location may be a high risk incident stretch of road (HRIS) which can include, but is not limited to, a stretch of heavily traveled road, a pedestrian right of way or crosswalk, a merging of two or more roads, a relatively sharp curve in a road, a relatively steep change in elevation, or any stretch of road having a turning lane.

In one or more embodiments, the smart street light systems and methods may include one or more example smart street light devices, each with at least one respective communications component to aid and expedite the assistance of emergency service providers to the incident. The smart street light systems and methods may utilize a microphone and/or speaker embedded in a lighting component or other device adjacent to the monitored intersection to improve communications between emergency service providers and a person at the intersection. The smart street light systems and methods may also employ an indicia component to allow the lighting component to flash, for example, red and blue, thereby alerting not only emergency service providers, but also incoming vehicles, of the vehicular incident.

In at least one aspect of certain embodiments, the communications component can also initiate automated communications to at least one emergency service provider regarding the collision incident at the monitored street location. In this example, the automated communications can include information associated with the vehicle including, but not limited to, an exterior view of the car, the license plate, vehicle identification number (VIN) or other unique identifier associated with the car, and speed of the car.

In at least one aspect of certain embodiments, the communications component can initiate specific communications with multiple emergency service providers depending on a type of vehicle incident and/or vehicular collision involved. In one example, fire and/or smoke may be detected at a site of the vehicle incident and/or vehicular collision, and in response, a fire department can be contacted or otherwise dispatched via communications from the smart street light system and/or communications component. In another example, depending on a severity of the vehicle incident and/or vehicular collision, such as based on the speed or velocity of a vehicle involved and/or detection of the deployment of airbags in one or more vehicles, one or more injuries to drivers or passengers in a vehicle may be predicted, and one or more emergency medical technicians and/or emergency medical transportation can contacted or otherwise dispatched via communications from the smart street light system and/or communications component. In yet another example, certain characteristics of a vehicle incident and/or vehicular collision can be detected or otherwise determined, such as involving a chemical spill, and one or more fire departments and/or hazardous material handling services can be contacted or otherwise dispatched via communications from the monitoring system and/or communications component. In another example, communications can be received from one or more persons at a site of the vehicle incident and/or vehicular collision, and in response, a suitable selection and/or determination of emergency service providers can be contacted or otherwise dispatched via communications from the smart street light system and/or communications component.

In at least one aspect of certain embodiments, the at least one emergency service provider can include, but is not limited to, a police department, a 911 call operator, a hospital, a fire department, a hazardous material handling service, an emergency medical technician, and an emergency medical transportation.

One skilled in the art will recognize other smart street light system and method embodiments with any number of combinations of the disclosed components to be within the scope of the present disclosure. One skilled in the art will recognize existing devices, processes, and techniques that may be equivalent to the disclosed components and/or embodiments.

One will recognize that each of the memory devices or data storage devices described herein may include a machine readable medium on which is stored one or more sets of data structures or instructions (e.g., software) embodying or utilized by any one or more of the techniques or functions described herein. For example, the data structures or instructions can embody or can be utilized by the functions and techniques described with respect to FIGS. 1-9. The instructions may also reside, completely or at least partially, within a main memory, within a static memory, or within a hardware processor during execution thereof by the device, machine or system. In an example, one or any combination of the hardware processor, the main memory, the static memory, or the storage device may constitute machine-readable media.

While the machine-readable medium is illustrated as a single medium, the term “machine-readable medium” may include a single medium or multiple media (e.g., a centralized or distributed database, and/or associated caches and servers) configured to store the one or more instruction.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by a machine or device and that cause the machine or device to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Additional types of CRSM that may be present in any of the devices described herein may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other medium which can be used to store the information and which can be accessed. Combinations of any of the above are also included within the scope of CRSM. Alternatively, computer-readable communication media (CRCM) may include computer-readable instructions, program modules, or other data transmitted within a data signal, such as a carrier wave, or other transmission. However, as used herein, CRSM does not include CRCM.

The instructions may further be transmitted or received over a communications network using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver may include one or more physical jacks (e.g., Ethernet, coaxial, or phone jacks) or one or more antennas to connect to the communications network. In an example, the network interface device/transceiver may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine or device and includes digital or analog communications signals or other intangible media to facilitate communication of such software.

The word “exemplary” is used herein to mean “serving as an example, instance, or illustration.” Any embodiment described herein as “exemplary” is not necessarily to be construed as preferred or advantageous over other embodiments. The terms “monitoring and computing device,” “user device,” “communication station,” “station,” “handheld device,” “mobile device,” “wireless device” and “user equipment” (UE) as used herein refers to a wireless communication device such as a cellular telephone, a cell phone, a smart phone or smartphone, a tablet, a netbook, a wireless terminal, a laptop computer or laptop, a desktop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an offboard device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or operations. Thus, such conditional language is not generally intended to imply that features, elements, and/or operations are in any way required for one or more embodiments.

The claimed disclosure is:

1. A street light device comprising:
an object tracking component; a communications component; a lighting component; a computer processor; and a memory storing computer-executable instructions, that when executed by the processor, cause the processor to: identify via the object tracking component a moving vehicle traveling towards a
monitored street location; determine via the object tracking component a distance of the moving vehicle from
the monitored street location; determine via the object tracking component a speed of the moving vehicle; and control a brightness of the lighting component based on the speed and proximity of
the moving vehicle.

2. The street light device of claim 1, wherein the computer-executable instructions further cause the processor to: transmit via the communications component a speed and proximity of the moving vehicle to one or more adjacent street light devices via one or more communication networks; wherein based at least in part on the speed and proximity of the moving vehicle, facilitate control of a brightness of the one or more adjacent street light devices.

3. The street lighting device of claim 1, further comprising:
wherein the computer-executable instructions further cause the processor to:
transmit via the communications component instructions to facilitate control of a brightness of one or more adjacent street light devices in coordination with the brightness of the lighting component.

4. The street lighting device of claim 1, further comprising:
wherein the computer-executable instructions further cause the processor to:
receive via the communications component instructions to control the brightness of the lighting component in response to an indication from one or more adjacent street light devices of a speed and proximity of the moving vehicle.

5. A method comprising:
identifying a moving vehicle traveling towards a monitored street location; determining a distance of the moving vehicle from the monitored street location; determining a speed of the moving vehicle; controlling a brightness of one or more lighting components based on a proximity of the
moving vehicle to each of the one or more lighting components; capturing one or more images of the moving vehicle as the vehicle approaches the
monitored street location, detecting and/or determining a collision incident associated with the vehicle; based at least in part on the collision incident, transmitting an alert to at least one emergency service provider via one or more communication networks; and based at least in part on the collision incident, facilitating communications between a driver
of the moving vehicle and the at least one emergency service provider.

6. The method of claim 5, wherein the distance comprises about 200 meters.

7. The method of claim 5, further comprising:
storing the one or more images in a remote storage device; and/or storing
the one or more images on a local hard drive.

8. The method of claim 5, wherein facilitating communications comprises providing communications via a microphone and
speaker located at the monitored street location, wherein the location of the microphone and speaker are identified with a flashing light.

9. The method of claim 5, wherein facilitating communications comprises initiating automated communications to the at least one emergency service provider regarding the collision incident at the monitored street location, wherein the automated communications comprise information associated with the vehicle.

10. The method of claim 5, wherein the collision incident comprises two or more vehicles.

11. The method of claim 5, wherein the one or more images comprise the license plate of the vehicle and the speed of the vehicle.

12. The method of claim 5, wherein the at least one emergency service provider comprises at least one of the following: police, hospital, fire department, emergency medical technician, and emergency medical transportation.

13. A monitoring system comprising:
an object tracking component; a recording component; a communications component; a computer processor; and a memory storing computer-executable instructions, that when executed by the processor, cause the processor to: identify via the object tracking component a moving vehicle traveling towards a
monitored street location; determine via the object tracking component a distance of the moving vehicle from
the monitored street location; determine via the object tracking component a speed of the moving vehicle; control a brightness of one or more lighting components based on a proximity of
the moving vehicle to each of the one or more lighting components; capture via a recording component one or more images of the moving vehicle as
the vehicle approaches the monitored street location; detect and/or determine a collision incident associated with the vehicle; based at least in part on the collision incident, transmit via the communications component an alert to at least one emergency service provider via one or more communication networks; and based at least in part on the collision incident, facilitate via the communications component communications between a driver of the moving vehicle and at least one emergency service provider.

14. The monitoring system of claim 13, wherein the distance comprises about 200 meters.

15. The monitoring system of claim 13, wherein the computer-executable instructions further cause the processor to:
store one or more images in a remote storage device; and/or store
of one or more images on a local hard drive.

16. The monitoring system of claim 13, wherein the computer-executable instructions that facilitate communications further comprise instructions to provide communications via a microphone and speaker located at the monitored street location, wherein the location of the microphone and speaker are identified with a flashing light.

17. The monitoring system of claim 13, wherein the computer-executable instructions that facilitate communications further comprise instructions to initiate automated communications to the at least one emergency service provider regarding the collision incident at the monitored street location, wherein the automated communications comprise information associated with the vehicle.

18. The monitoring system of claim 13, wherein the collision incident comprises two or more vehicles.

19. The monitoring system of claim 13, wherein the one or more images comprise the license plate of the vehicle and the speed of the vehicle.

20. The monitoring system of claim 13, wherein the at least one emergency service provider comprises at least one of the following: police, hospital, fire department, emergency medical technician, and emergency medical transportation.
